(19) United States
(12) Patent Application Publication
(10) Pub. No.: US 2026/0336564 A1
(43) Pub. Date: Oct. 29, 2026

(54) WASHER NOZZLE DEFROSTING DEVICE

(71) Applicant: SUBARU CORPORATION, Tokyo (JP)

(72) Inventor: Mitsuo AOKI, Tokyo (JP)

(73) Assignee: SUBARU CORPORATION, Tokyo (JP)

(21) Appl. No.: 19/391,884

(22) Filed: Nov. 17, 2025

(30) Foreign Application Priority Data
Nov. 26, 2024 (JP) 2024-205670

(51) Int. Cl. B60S 1/02; B60S 1/48; B60S 1/52

(52) U.S. Cl. CPC B60S 1/026; B60S 1/485; B60S 1/52

(57) ABSTRACT

A washer nozzle defrosting device includes an inverter, a washer nozzle, a vibration element, wiring, and a control circuit. The inverter is coupled to a battery configured to supply power to a motor generator. The washer nozzle is configured to spray washer fluid. The vibration element is provided in contact with the washer nozzle and configured to generate an ultrasonic vibration. The wiring is configured to couple the inverter and the vibration element. The control circuit is configured to control the inverter.

### CROSS-REFERENCE TO RELATED APPLICATIONS

The present application claims priority from Japanese Patent Application No. 2024-205670 filed on Nov. 26, 2024, the entire contents of which are hereby incorporated by reference.

### BACKGROUND

The disclosure relates to the technical field of washer nozzle defrosting devices.

Conventionally, a washer nozzle has been proposed in which an ultrasonic transducer is provided inside the nozzle body, and when the washer spray orifice becomes frozen, an ultrasonic vibration is generated from the ultrasonic transducer to defrost the washer spray orifice through the ultrasonic vibration (for example, Japanese Unexamined Patent Application Publication (JP-A) No. 2017-109722).

### SUMMARY

An aspect of the disclosure provides a washer nozzle defrosting device including an inverter, a washer nozzle, a vibration element, wiring, and a control circuit. The inverter is coupled to a battery configured to supply power to a motor generator. The washer nozzle is configured to spray washer fluid. The vibration element is provided in contact with the washer nozzle and configured to generate an ultrasonic vibration. The wiring is configured to couple the inverter and the vibration element. The control circuit is configured to control the inverter.

### BRIEF DESCRIPTION OF THE DRAWINGS

The accompanying drawings are included to provide a further understanding of the disclosure and are incorporated in and constitute a part of this specification. The drawings illustrate embodiments and, together with the specification, serve to describe the principles of the disclosure.

FIG. 1 is a diagram illustrating an overview of the configuration of a vehicle;

FIG. 2 is a perspective view illustrating the structure of the front part of the vehicle;

FIG. 3 is a diagram illustrating the configuration of a washer nozzle;

FIG. 4 is a flowchart illustrating the flow of a washer nozzle defrosting process;

FIG. 5 is a diagram illustrating a map for estimating the freezing level based on the outside air temperature history;

FIG. 6 is a diagram illustrating the frequency and gain per freezing level; and

FIG. 7 is a flowchart illustrating the flow of a washer nozzle defrosting process according to a modification.

### DETAILED DESCRIPTION

In the techniques disclosed in JP-A No. 2017-109722, it is necessary to provide a device for generating an ultrasonic vibration from the ultrasonic transducer, which may complicate the configuration.

In view of the above-described circumstances, it is desirable to defrost the washer nozzle with a simple configuration.

In the following, an embodiment of the disclosure is described in detail with reference to the accompanying drawings. Note that the following description is directed to an illustrative example of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiment which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same numerals to avoid any redundant description.

### 1. Vehicle Configuration

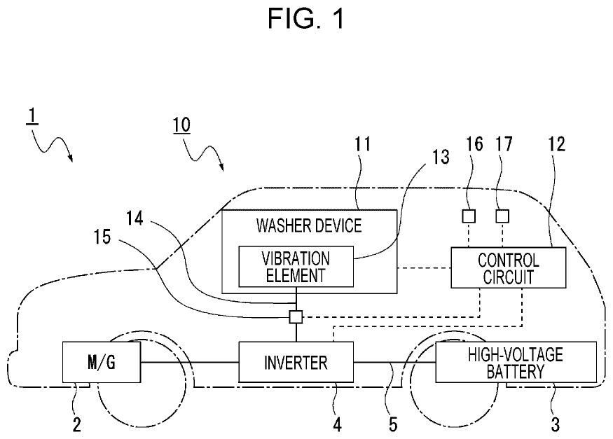

FIG. 1 is a diagram illustrating an overview of the configuration of a vehicle 1. As illustrated in FIG. 1, the vehicle 1 is an electric or hybrid vehicle equipped with a motor generator 2 (denoted as “M/G” in FIG. 1) as a power source. The vehicle 1 is equipped with the motor generator 2, a high-voltage battery 3, an inverter 4, a power transmission cable 5, and a washer nozzle defrosting device 10.

The motor generator 2 is a power source for driving the vehicle 1 and is, for example, a three-phase alternating current (AC) motor. The motor generator 2 generates driving force by the power supplied from the high-voltage battery 3 via the inverter 4 and the power transmission cable 5, and the vehicle 1 is driven by transmitting this driving force to the drive wheels. When the vehicle 1 is a hybrid vehicle, the vehicle 1 is also provided with an engine as a power source.

The motor generator 2 is capable of generating power by performing regenerative operation. The power generated by the regenerative operation of the motor generator 2 is supplied to the high-voltage battery 3 via the inverter 4 and the power transmission cable 5.

The inverter 4 converts the direct current supplied from the high-voltage battery 3 into three-phase alternating current and supplies it to the motor generator 2 via the power transmission cable 5. Additionally, when the motor generator 2 performs regenerative operation, the inverter 4 converts the alternating current supplied from the motor generator 2 into direct current and supplies it to the high-voltage battery 3 via the power transmission cable 5.

The inverter 4 is, for example, a variable voltage variable frequency (VVVF) inverter equipped with six switching elements. The switching elements are, for example, insulated gate bipolar transistors (IGBTs) having diodes coupled in antiparallel. The switching elements are coupled in series in pairs to form the U-phase, V-phase, and W-phase legs. In these legs, the first elements of the pairs of series-coupled switching elements are coupled in parallel to the positive terminal of the high-voltage battery 3, while the second elements are coupled in parallel to the negative terminal of the high-voltage battery 3. The U-phase, V-phase, and W-phase terminals of the motor generator 2 are respectively coupled to the junctions of the switching elements that form the corresponding legs.

The switching elements operate based on the pulse width modulation (PWM) control of a control circuit 12, which will be described in detail later. In one example, the switching elements operate in response to control signals input to their gates from the control circuit 12, and output alternating current of a predetermined frequency and voltage to the respective terminals of the motor generator 2.

The high-voltage battery 3 is a secondary battery, such as a lithium-ion battery, that outputs and stores power at a high voltage of, for example, 100 V or 200 V. The high-voltage battery 3 is capable of being charged by regenerative operation of the motor generator 2. Additionally, the high-voltage battery 3 may be chargeable by power supply from an external device (not illustrated).

The washer nozzle defrosting device 10 is equipped with a washer device 11, the control circuit 12, a vibration element 13, wiring 14, a switch element 15, a defrost switch 16, and an outside air temperature sensor 17. The high-voltage battery 3 and the inverter 4 also serve as part of the washer nozzle defrosting device 10.

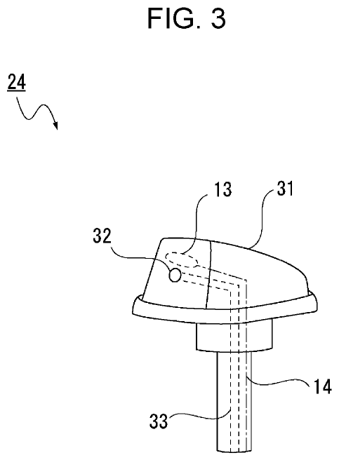

The washer nozzle defrosting device 10 is a device for defrosting a washer nozzle 24 (FIG. 3; may be provided as a pair of nozzles) of the washer device 11 when the washer nozzle 24 is frozen. a nozzle 24, which may be provided as a pair of nozzles.

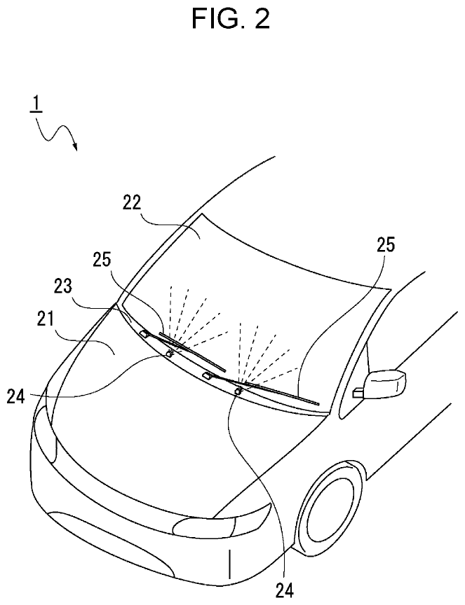

The washer device 11 is a device for spraying washer fluid onto a windshield 22, and includes the washer nozzle 24, as illustrated in FIG. 2, and a pump and the like for spraying washer fluid from the washer nozzle 24.

FIG. 2 is a perspective view illustrating the structure of the front part of the vehicle. As illustrated in FIG. 2, the front part of the vehicle 1 is provided with a hood 21 and the windshield 22. A cowl louver 23, which is adjacent to the front edge of the windshield 22 and is disposed at the boundary with the hood 21, is mounted with the washer nozzles 24 and wiper mechanisms 25.

The washer nozzles 24 spray washer fluid toward the windshield 22.

The wiper mechanisms 25 are each disposed so that a rubber attached to a blade contacts the windshield 22, and, when operated, wipe off raindrops or dirt on the windshield 22.

Referring back to FIG. 1, the washer device 11 (more precisely, the washer nozzle 24) is provided with the vibration element 13. The vibration element 13 is, for example, a capacitor or a reactor, and is capable of generating an ultrasonic vibration.

FIG. 3 is a diagram illustrating the configuration of the washer nozzle 24. As illustrated in FIG. 3, the washer nozzle 24 is provided with a nozzle cover 31. The nozzle cover 31 is formed of resin, for example, and a nozzle spray orifice 32 is formed on an upper side surface thereof.

A washer pipe 33 is coupled to the nozzle spray orifice 32. Washer fluid stored in a washer fluid tank (not illustrated) is guided to the nozzle spray orifice 32 through the washer pipe 33 and is sprayed from the nozzle spray orifice 32 toward the windshield 22.

In the washer nozzle 24, the vibration element 13 is mounted in the vicinity of the nozzle spray orifice 32 and the washer pipe 33. The vibration element 13 is accommodated within the nozzle cover 31, but may alternatively be provided outside the nozzle cover 31. That is, the vibration element 13 is simply disposed in contact with the washer nozzle 24, regardless of whether it is located inside or outside the washer nozzle 24.

One end of the wiring 14 is coupled to the vibration element 13. The other end of the wiring 14 is coupled to the inverter 4. In one example, the other end of the wiring 14 is coupled to the junction of the switching element pair of any of the three legs (e.g., the U-phase leg) of the inverter 4.

Accordingly, the wiring 14 couples the vibration element 13 and the inverter 4, and is capable of transmitting the electrical vibration generated by the inverter 4 to the vibration element 13.

The vibration element 13 converts the electrical vibration transmitted from the inverter 4 into a mechanical vibration. In one example, the vibration element 13 has a mechanical resonance point at the carrier frequency during operation of the inverter 4, and generates an ultrasonic vibration at a frequency corresponding to the carrier frequency of the inverter 4. In addition, the vibration element 13 ultrasonically vibrates with a gain (amplitude) proportional to the amplitude (voltage) of the electrical vibration generated by the inverter 4.

Accordingly, in the washer nozzle defrosting device 10, the frequency and gain (amplitude) of the ultrasonic vibration generated by the vibration element 13 can be varied by changing the carrier frequency and voltage of the inverter 4.

The switch element 15 is provided in the middle of the wiring 14. The switch element 15 switches between coupling and decoupling of the vibration element 13 and the inverter 4 based on control by the control circuit 12.

The control circuit 12 is an electronic control unit (ECU), and performs the operation control of the inverter 4, the operation control of the washer device 11, and the on/off control of the switch element 15. Note that the control circuit 12 may be configured by multiple ECUs, and the operation control of the inverter 4, the operation control of the washer device 11, and the on/off control of the switch element 15 may be performed by different ECUs.

The defrost switch 16 is a switch operated by a driver who drives the vehicle 1 to cause the control circuit 12 to execute processing for defrosting the washer nozzle 24 when the washer nozzle 24 is frozen. When the defrost switch 16 is operated, the control circuit 12 performs various processes for defrosting the washer nozzle 24 based on the operation.

### 2. Washer Nozzle Defrosting Process

Next, a washer nozzle defrosting process for defrosting the washer nozzle 24 when the washer nozzle 24 is frozen will be described.

Here, freezing of the washer nozzle 24 includes both cases in which moisture adhering around the nozzle spray orifice 32 freezes and cases in which washer fluid in the washer pipe 33 freezes. When the washer nozzle 24 is frozen, even if a washer switch (not illustrated) is operated to activate the washer device 11, washer fluid will not be sprayed from the washer nozzle 24. As a result, raindrops or dirt on the surface of the windshield 22 cannot be wiped off.

Accordingly, the vehicle 1 executes the washer nozzle defrosting process to defrost the washer nozzle 24 when the washer nozzle 24 is frozen.

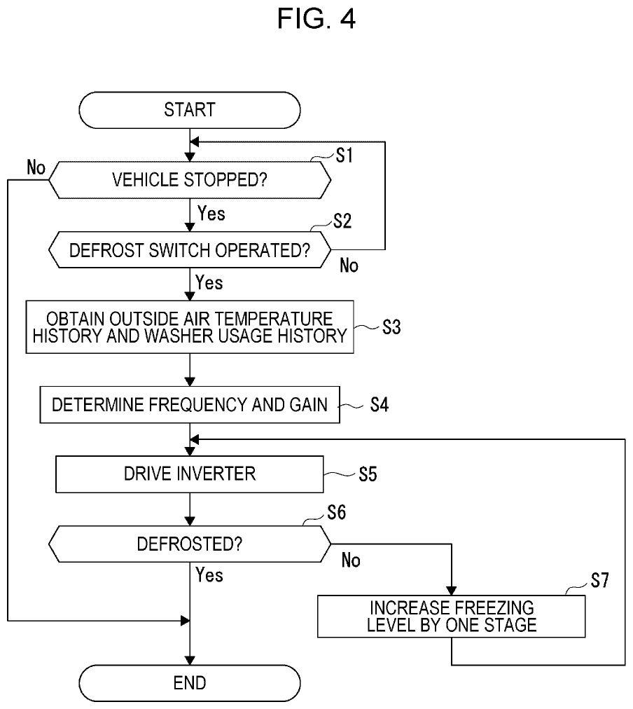

FIG. 4 is a flowchart illustrating the flow of the washer nozzle defrosting process. The process for defrosting the washer nozzle 24 is initiated when a start switch is operated and the vehicle 1 becomes READY-ON.

As illustrated in FIG. 4, once the washer nozzle defrosting process is initiated, in step S1, the control circuit 12 determines whether the vehicle 1 is stopped. Since the carrier frequency and voltage of the inverter 4 are to be changed in the washer nozzle defrosting process, it is better to execute the process when the motor generator 2 is not operating. Therefore, in step S1, it is determined whether the vehicle 1 is stopped. It should be noted that whether the vehicle 1 is stopped can be determined, for example, based on the measurement result of a vehicle speed sensor (not illustrated).

If the vehicle 1 is not stopped (NO in step S1), the washer nozzle defrosting process ends. If the vehicle 1 is stopped (YES in step S2), in step S2, the control circuit 12 determines whether the defrost switch 16 has been operated.

If the defrost switch 16 has not been operated (NO in step S2), that is, if the driver determines that it is unnecessary to defrost the washer nozzle 24, the process returns to step S1. If the defrost switch 16 has been operated (YES in step S2), in step S3, the control circuit 12 obtains an outside air temperature history indicating the measurement results of the outside air temperature sensor 17, and a washer usage history indicating the usage history of the washer device 11.

The outside air temperature history includes information on the outside air temperature at predetermined intervals in the past. The washer usage history includes information on the date and time at which the washer device 11 was used.

In step S4, the control circuit 12 determines the frequency and gain of an ultrasonic vibration generated by the vibration element 13 based on the outside air temperature history and the washer usage history.

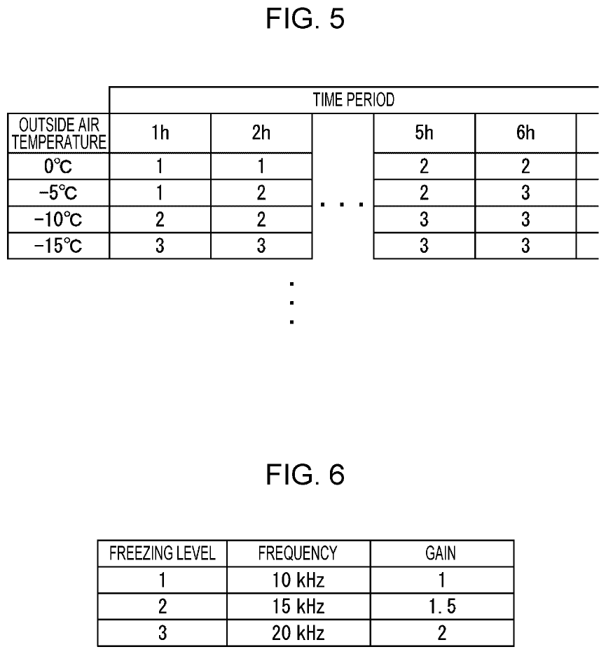

FIG. 5 is a diagram illustrating a map for estimating the freezing level based on the outside air temperature history. FIG. 6 is a diagram illustrating the frequency and gain per freezing level.

In step S4, the control circuit 12 first determines the freezing level based on the outside air temperature history. The freezing level is, for example, set to three stages. Freezing level “1” corresponds to a level at which the washer nozzle 24 is considered to be surface-frozen, representing the lowest freezing level. Freezing level “2” corresponds to a level at which the washer nozzle 24 is considered to be moderately frozen, representing the intermediate freezing level. Freezing level “3” corresponds to a level at which the washer nozzle 24 is considered to be deeply frozen, representing the highest freezing level.

Upon obtaining the outside air temperature history, the control circuit 12 determines the freezing level with reference to the estimation map illustrated in FIG. 5, based on the time during which the vehicle 1 was stopped and the outside air temperature at that time. For example, when the outside air temperature is −5 °C and the vehicle 1 was stopped for five hours (5 h), the control circuit 12 determines the freezing level to be “2”.

However, because the outside air temperature may change while the vehicle 1 is stopped, the outside air temperature may be accumulated every hour, for example, and the freezing level may be determined based on the accumulated outside air temperature. In this case, it is conceivable to use an estimation map indicating the freezing level corresponding to the accumulated outside air temperature.

Furthermore, the control circuit 12 modifies the freezing level based on the washer usage history. For example, if the washer device 11 was used immediately before the vehicle 1 was stopped, washer fluid remains around the nozzle spray orifice 32, representing a condition in which the washer nozzle 24 is more likely to freeze; therefore, the freezing level is increased by 1.

However, the control circuit 12 may be configured not to modify the freezing level based on the washer usage history.

Upon determining the freezing level in this manner, the control circuit 12 determines the frequency and gain of the ultrasonic vibration according to the freezing level, as illustrated in FIG. 6. As illustrated in FIG. 6, at freezing level “1”, the frequency is determined to 10 kHz and the gain is determined to be 1. Note that the gain refers to the amplification factor relative to a predetermined amplitude of the ultrasonic vibration.

In step S5, the control circuit 12 operates the inverter 4 so that an ultrasonic vibration having the determined frequency and gain is generated from the vibration element 13. Here, the inverter 4 is controlled to operate at a carrier frequency and voltage corresponding to the determined frequency and gain. The control circuit 12 also turns on the switch element 15 to couple the inverter 4 and the vibration element 13.

As a result, the electrical signal generated by the inverter 4 is transmitted to the vibration element 13, and the vibration element 13 generates an ultrasonic vibration having the determined frequency and gain.

The vibration element 13 transmits the generated ultrasonic vibration to the frozen part (ice molecules) of the washer nozzle 24, thereby causing the ice molecules to generate heat and melt.

At this time, the higher the frequency of the ultrasonic vibration, the greater the distance (depth) over which the ultrasonic vibration is transmitted. Accordingly, by increasing the frequency as the freezing level rises, the ultrasonic vibration can be transmitted deeper into the frozen part, enabling the washer nozzle 24 to be defrosted more rapidly.

Additionally, the higher the gain of the ultrasonic vibration, the greater the vibration energy. Therefore, by increasing the gain as the freezing level rises, the vibration energy can be further increased, enabling the washer nozzle 24 to be defrosted more rapidly.

In step S6, the control circuit 12 determines whether the washer nozzle 24 has been defrosted. Even if the defrost switch 16 is operated to perform the process for defrosting the washer nozzle 24, when the washer nozzle 24 has not been defrosted, the driver operates the defrost switch 16 again. Accordingly, the control circuit 12 determines that the washer nozzle 24 has been defrosted when the defrost switch 16 has not been operated again by the driver within a predetermined period of time, or when the vehicle 1 has started moving.

If the washer nozzle 24 has not been defrosted (NO in step S6), in step S7, the control circuit 12 increases the freezing level by one stage and returns the process to step S5. This enables the washer nozzle 24 to be defrosted more rapidly.

In contrast, if the washer nozzle 24 has been defrosted (YES in step S6), the washer nozzle defrosting process ends.

### 3. Modifications

Although the embodiment of the disclosure has been described above, the disclosure is not limited to the examples described above and may take various configurations.

For example, in the above-described embodiment, the control circuit 12 determines the frequency and gain of the ultrasonic vibration based on the outside air temperature history and the washer usage history. However, the control circuit 12 may determine the frequency and gain of the ultrasonic vibration based on one or both of the outside air temperature history and the washer usage history.

Additionally, in the above-described embodiment, the washer nozzle defrosting process is executed when the vehicle 1 is stopped. However, the washer nozzle defrosting process may be performed when the vehicle 1 is traveling.

Furthermore, although the freezing level is set to three stages in the above-described embodiment, the freezing level may be set to any number of stages.

In the above-described embodiment, the washer nozzle defrosting device 10 configured to defrost the washer nozzle 24 configured to spray washer fluid onto the windshield 22 has been described. However, the washer nozzle defrosting device 10 may also be configured to defrost a washer nozzle configured to spray washer fluid onto the rear windshield or a washer nozzle configured to spray washer fluid onto the headlights.

Moreover, in the above-described embodiment, the technique for defrosting the washer nozzle 24 has been described. However, when defrosting door handles, the fuel filler flap, the charging flap, the hood, the rear hatch, or the like, the above-described technique for defrosting the washer nozzle 24 may also be applied.

At this time, the vehicle 1 may be accessed from an external terminal, such as a smartphone, and the technique for defrosting the washer nozzle 24 may be remotely executed.

In the above-described embodiment, it is determined that the washer nozzle 24 has been defrosted when the defrost switch 16 has not been operated again by the driver within a predetermined period of time, or when the vehicle 1 has started moving. However, the control circuit 12 may determine that the washer nozzle 24 has been defrosted, for example, if the outside air temperature becomes higher than 0 °C.

Also, in the above-described embodiment, the control circuit 12 determines the frequency and gain of the inverter 4 based on the outside air temperature history and the washer usage history. However, the control circuit 12 may determine the frequency of the inverter 4 based on one or both of the outside air temperature history and the washer usage history, and determine the gain based on whether or not the washer nozzle 24 has been defrosted.

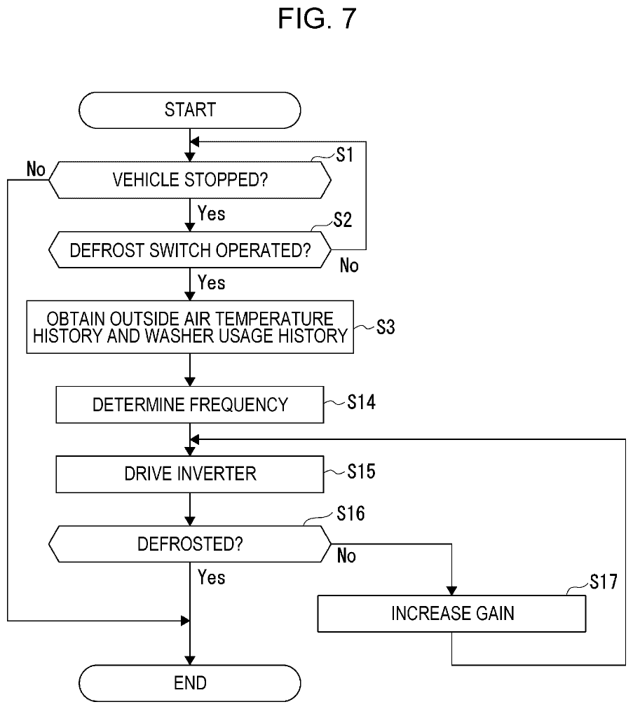

FIG. 7 is a flowchart illustrating the flow of a washer nozzle defrosting process according to a modification. Note that the same processing as that in the washer nozzle defrosting process in FIG. 4 is denoted by the same reference numeral, and its description is omitted.

As illustrated in FIG. 7, upon obtaining the outside air temperature history and the washer usage history in step S3, the control circuit 12 determines the freezing level in step S14. Note that the method for determining the freezing level is the same as that in step S4. The control circuit 12 then determines the frequency of the ultrasonic vibration alone based on the freezing level. That is, the frequency is determined with reference to the relationship between the freezing level and the frequency alone in FIG. 6. Additionally, the control circuit 12 determines the gain to be “1”.

Then, in step S15, the control circuit 12 operates the inverter 4 based on the determined frequency and gain. In step S16 thereafter, the control circuit 12 determines whether the washer nozzle 24 has been defrosted. Then, if the washer nozzle 24 has not been defrosted (NO in step S16), in step S17, the control circuit 12 increases the gain by one stage and proceeds to step S15. In contrast, if the washer nozzle 24 has been defrosted (YES in step S16), the washer nozzle defrosting process ends.

As described above, it is also possible to determine the frequency of the ultrasonic vibration based on one or both of the outside air temperature history and the washer usage history, and to determine the gain based on whether or not the washer nozzle 24 has been defrosted.

### 6. Summary of Embodiment

As described above, the washer nozzle defrosting device 10 of the embodiment includes: the inverter 4 coupled to a battery (high-voltage battery 3) configured to supply power to the motor generator 2; the washer nozzle 24 configured to spray washer fluid; the vibration element 13 provided in contact with the washer nozzle 24 and configured to generate an ultrasonic vibration; the wiring 14 configured to couple the inverter 4 and the vibration element 13; and the control circuit 12 configured to control the inverter 4.

Accordingly, in the washer nozzle defrosting device 10, an ultrasonic vibration can be generated from the vibration element 13 by transmitting the electrical vibration generated by the inverter 4 to the vibration element 13.

Therefore, in the washer nozzle defrosting device 10, it is unnecessary to newly provide a device for generating an ultrasonic vibration from the vibration element 13. Thus, the washer nozzle defrosting device 10 can defrost the washer nozzle 24 with a simple configuration.

The control circuit 12 determines the frequency and gain of an ultrasonic vibration generated by the vibration element 13 based on the outside air temperature, and controls the inverter 4 so that an ultrasonic vibration at the determined frequency and gain is generated from the vibration element 13.

As a result, an ultrasonic vibration can be generated from the vibration element 13 at an optimal frequency and gain according to the freezing condition (freezing level) of the washer nozzle 24. Therefore, the washer nozzle defrosting device 10 can reduce the time involved in defrosting the washer nozzle 2. The washer nozzle defrosting device 10 can also minimize the energy for generating an ultrasonic vibration from the vibration element 13.

The control circuit 12 determines the freezing condition (freezing level) of the washer nozzle 24 based on the usage history of the washer device 11.

As a result, if the washer nozzle defrosting device 10 was used immediately beforehand, washer fluid remains around the nozzle spray orifice 32, enabling to determine a condition in which the washer nozzle 24 is more likely to freeze. Thus, the washer nozzle defrosting device 10 can accurately determine the freezing condition (freezing level) of the washer nozzle 24.

When the washer nozzle 24 has not been defrosted, the control circuit 12 controls the inverter 4 to change one or both of the frequency and gain of the ultrasonic vibration generated by the vibration element 13.

This enables the washer nozzle 24 to be defrosted more rapidly.

When the washer nozzle 24 has not been defrosted, the control circuit 12 controls the inverter 4 to increase the gain of an ultrasonic vibration generated by the vibration element 13.

This increases the vibration energy of the ultrasonic vibration generated from the vibration element 13, thereby enabling the washer nozzle 24 to be defrosted more rapidly.

According to the disclosure, the washer nozzle can be defrosted with a simple configuration.

The control circuit 12 illustrated in FIG. 1 can be implemented by circuitry including at least one semiconductor integrated circuit such as at least one processor (e.g., a central processing unit (CPU) ), at least one application specific integrated circuit (ASIC), and/or at least one field programmable gate array (FPGA). At least one processor can be configured, by reading instructions from at least one machine readable tangible medium, to perform all or a part of functions of the control circuit 12. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the non-volatile memory may include a ROM and a NVRAM. The ASIC is an integrated circuit (IC) customized to perform, and the FPGA is an integrated circuit designed to be configured after manufacturing in order to perform, all or a part of the functions of the modules illustrated in FIG. 1.

1. A washer nozzle defrosting device comprising:
an inverter coupled to a battery configured to supply power to a motor generator;
a washer nozzle configured to spray washer fluid;
a vibration element provided in contact with the washer nozzle and configured to generate an ultrasonic vibration;
wiring configured to couple the inverter and the vibration element; and
a control circuit configured to control the inverter.

2. The washer nozzle defrosting device according to claim 1, wherein:
the control circuit is configured to determine a frequency and gain of an ultrasonic vibration generated by the vibration element based on an outside air temperature, and control the inverter so that an ultrasonic vibration at the determined frequency and gain is generated from the vibration element.

3. The washer nozzle defrosting device according to claim 1, wherein:
the control circuit is configured to determine a freezing condition of the washer nozzle based on a usage history of a washer device.

4. The washer nozzle defrosting device according to claim 2, wherein:
the control circuit is configured to determine a freezing condition of the washer nozzle based on a usage history of a washer device.

5. The washer nozzle defrosting device according to claim 2, wherein:
the control circuit is configured to, when the washer nozzle has not been defrosted, control the inverter to change one or both of the frequency and gain of the ultrasonic vibration generated by the vibration element.

6. The washer nozzle defrosting device according to claim 2, wherein:
the control circuit is configured to, when the washer nozzle has not been defrosted, control the inverter to increase the gain of the ultrasonic vibration generated by the vibration element.
